(19) United States
(12) Patent Application Publication
(10) Pub. No.: US 2005/0214631 A1
(43) Pub. Date: Sep. 29, 2005

(54) Fuel cell and membrane electrode assembly

(76) Inventor: Takayuki Hirashige, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/063,990

(22) Filed: Feb. 24, 2005

(30) Foreign Application Priority Data
Mar. 26, 2004 (JP) 2004-091721

(51) Int. Cl. H01M 4/96

(52) U.S. Cl. 429/44; 429/42

(57) ABSTRACT

A fuel cell anode for oxidizing fuel, a cathode for reducing oxygen and a solid polymer electrolyte membrane sandwiched between the anode and the cathode, wherein the cathode comprises a catalyst supporter having a catalyst metal and a material having a polymer proton conductivity and a material having water-repellency, the material having water-repellency being electric conductive. The material having water-repellency is a carbonaceous material such as graphite intercalation compound, activated charcoal, carbonaceous material having water-repellent function groups. The disclosure is also related to a membrane electrode assembly comprising an anode catalyst layer, a proton conductive polymer electrolyte membrane and a cathode catalyst layer, the anode catalyst layer, the membrane and the cathode catalyst layer being laminated and united, wherein the catalyst layers contain carbon supporting metal catalyst and a water-repellent material, the water-repellent material being electrically conductive.

### CLAIM OF PRIORITY

The present application claims of priority from Japanese Application filed on Mar. 26, 2004, the content of which is hereby incorporated by reference into this application.

### THE FIELD OF THE INVENTION

The present invention relates to a fuel cell and a membrane electrode assembly for the fuel cell.

### RELATED ART

Fuel cells are devices for directly converting chemical energy by oxidation-reduction reaction into electric energy. That is, fuel such as hydrogen, methanol, etc is reacted with an oxidizing gas such as air, etc to take out electric energy. Fuel cells are classified in accordance with kinds of electrolytes and operating temperatures into a solid polymer type, a phosphate type, a molten carbonate type, a solid electrolyte type, etc.

Among the fuel cells, the solid polymer electrolyte type fuel cell (PEFC) uses an electrolyte membrane of perfluoro-carbon sulfonate resin wherein hydrogen is oxidized at an anode and oxygen is reduced at a cathode to take out electric energy. A direct type methanol fuel cell (DMFC; Direct Methanol Fuel Cell) has been spotlighted.

The electrode structure for these fuel cells has catalyst layers on both faces of the solid polymer electrolyte as a proton conductor and gas diffusion layers on the catalyst layers, the gas diffusion layers being gas suppliers and electric collectors.

The catalyst layers is constituted as a matrix comprising a mixture of carbon particles for supporting a catalyst and the solid polymer electrolyte. At the three phase interface where the catalyst, the electrolyte and the reactants come into contact, the electrode reactions take place. The connection of the carbon particles is a path for electrons, and the connection of the electrolyte is a path for protons.

In the case of PEFC wherein hydrogen is fuel and air is oxidant, the electrode reactions at the anode and the cathode are (1) and (2).
H₂→2H⁺+2e⁻ (1)
O₂+4H⁺+4e⁻→2H₂O (2)

In the case of DMFC that uses a methanol aqueous solution as fuel, the following reaction (3) takes place at the anode.
CH₃OH+H₂O→CO₂+6H⁺+6e⁻ (3)

In any case of PEFC or DMFC, if the fuel cells are operated at high current density, a so-called flooding phenomenon is observed where produced water stays on the surface and pores of the catalyst layers are clogged so that passage for reactants may be closed to drastically lower an output of the fuel cells.

In order to prevent the flooding phenomenon, the catalyst layers are given water repellency by dispersing polytetrafluoroethylene (PTFE) particles in the catalyst layers thereby to release the produced water for the electrodes.

In order to prevent the stay of produced water in the electrodes at the time of high current density operation, an amount of the water repellent particles to be mixed in the electrodes may be increased. However, since PTFE particles do not have electric conductivity, the increased amount of PTFE may increase electric resistance of the electrodes; particularly, IR drop at high current density operation becomes large, which leads to an obstacle to an output of the fuel cells.

For the purpose of improving ability of water release, a concentration distribution or concentration gradient of the water repellent in the catalyst layers is formed as disclosed in the Patent Document No. 1. In consideration of the fact that the flooding phenomenon tends to occur in the vicinity of the interface of the catalyst layers and the electrolyte membrane, the area close to the interface between the catalyst layer and the membrane has higher water repellency to improve ability of water release or water dispersion.

However, since the method for giving the concentration gradient of the water repellent would make such a layer that has a high concentration of the water repellent, which has no electric conductivity, the electric resistance of the electrode will increase. As a result, the IR drop increases and the output of the fuel cell is limited.

In Patent Document No. 2, ethylene tetrafluoride-propylene hexafluoride copolymer is used as a water repellent material. However, since this material does not have electric conductivity, the electric resistance of the electrode will increase. In the conventional technologies, it was impossible to obtain electrodes that releases produced water and has electric conductivity as well.

Patent Document No. 1: Japanese Patent No. 3,245,929

Patent Document No. 1: Japanese Patent Laid-Open 2003-109601

### SUMMARY OF THE INVENTION

It is an object of the present invention to provide a fuel cell and a electrode for the fuel cell, which has water repellency and high output. The electrode has electric conductive, water repellent particles dispersed therein.

The present invention relates to a fuel cell comprising a solid polymer electrolyte and electrodes, wherein a cathode electrode has a catalyst layer containing water repellent, carbonaceous particles that are dispersed in the cathode. The fuel cell comprises a cathode catalyst layer for oxidizing fuel and an anode catalyst layer for reducing an oxidant gas, the solid polymer electrolyte being sandwiched between the catalyst layers, wherein the cathode catalyst layer comprises carbon particles supporting a catalyst, the solid polymer electrolyte having proton conductivity and a water repellent material, the water repellent material being electrically conductive.

The present invention also provides a membrane electrode assembly wherein an anode catalyst layer, a proton conductive polymer electrolyte and a cathode catalyst layer are united by bonding, laminating or coating, the catalyst layers contain carbon particles supporting platinum group metal catalyst and a water repellent, the water repellent being electrically conductive. The anode and the cathode comprise the catalyst metal, carbon supporting the catalyst metal and a solid polymer electrolyte.

According to the present invention, the cathode catalyst layer having sufficient water repellency exhibits good electric conductivity so that the releasing or dispersion of produced water is compatible with electric conductivity thereby to increase output of the fuel cell.

### BRIEF DESCRIPTION OF THE DRAWINGS

FIG. 1 is a cross sectional view of a fuel cell according to the present invention.

FIG. 2(a) is shows a plane view of a membrane-electrode assembly of the present invention, and FIG. 2(b) is a cross sectional view along the line A-A of FIG. 2(a).

FIG. 3 is a diagrammatic view of a structure of the membrane-electrode assembly of the present invention.

FIG. 4 is a graph showing I-V characteristics of the membrane-electrode assembly of the present invention and the conventional membrane-electrode assembly.

### DETAILED DESCRIPTION OF THE PREFERRED-EMBODIMENTS

In the present invention, the water repellency of graphite fluoride CₘFₙ (m, n; natural numbers) is defined by a contact angle of water being larger than 90° to 143°. The electric resistance of the water repellent material is defined as 1×10⁻² S/cm to 1×10⁵ S·cm in the case of CₘFₙ. Examples of functional groups retained on the surface of the water repellent are aromatic hydrocarbons such as benzene, naphthalene, etc, linear chain hydrocarbons such as ethylenic hydrocarbons represented by CₙH₂ₙ, acethylenic hydrocarbons represented by CₙH₂ₙ₋₂, cyclo-aliphatic hydrocarbons such as cycloalkanes, cycloalkenes, cycloalkines, etc.

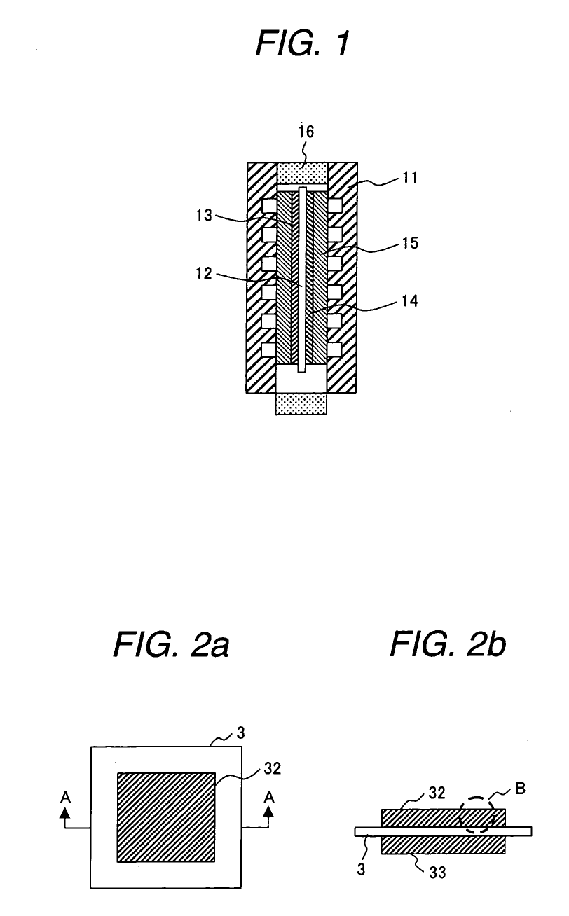

FIG. 1 shows an example of a fuel cell according to the present invention. In FIG. 1, numeral 11 denotes a separator, 12 a solid polymer electrolyte, 13 an anode catalyst layer, 14 a cathode catalyst layer, 15 a gas diffusion layer, and 16 a gasket.

The anode catalyst layer 13 and the cathode 14 are bonded or laminated to the solid polymer electrolyte 12. The assenbly is called a membrane electrode assembly (MEA). The separator 11 is electrically conductive and made of a dense graphite plate, a carbon plate comprising carbonaceous material such as graphite powder or carbon black bonded with a resin binder, or a corrosion resistive metal plate such as titanium, stainless steel. The surface of the separator 11 can be plated with noble metals or treated with a corrosion resistive, electrically conductive paint.

The surface of the separator 11, which faces the anode catalyst layer 13 and the cathode catalyst layer 14, has grooves; the anode side grooves are supplied with fuel and the cathode side grooves are supplied with oxygen or air. In the fuel cell wherein hydrogen is fuel and air is an oxidant, the following reactions (1), (2) at the anode 13 and the cathode 14 take place.
H₂→2H⁺+2e⁻ (1)
O₂+4H⁺+4e⁻→2H₂O (2)

In the case of DMFC that uses methanol aqueous solution as fuel, the following reaction (3) takes place at the anode.
CH₃OH+H₂O→CO₂+6H⁺+6e⁻ (3)

Protons generated in the reaction (1) or (3) move through the solid polymer electrolyte 12 to the cathode 14.

As the gas diffusion layer 15, carbon paper or carbon cloth is treated with a water repellent material. The gasket is electrically insulating; the material of the gasket should permeate little of hydrogen or methanol aqueous solution and should keep gas-tightness, such as butyl rubber, baiton rubber, EPDM rubber, etc.

Problems of the conventional MEA will be explained in the following. An MEA is prepared by laminating and uniting a solid polymer electrolyte, a cathode catalyst layer and an anode catalyst layer. The catalyst layers contain a catalyst metal such as platinum, etc, carbon particles supporting the catalyst metal and water repellent particles (in the conventional MEA, an electrically insulating material such as PTFE was used).

In the conventional MEA, the anode and the cathode were formed on both faces of the solid polymer electrolyte as a dense catalyst layers. The water repellent particles are normally distributed over the entire of the catalyst layer of the cathode. The conventional water repellent material such as PTFE is electrically insulating; the electric resistance of the electrode containing the water repellent material increases thereby to increase IR drop particularly at high current density, resulting in lowering an output.

In the present invention, a water repellent material having electric conductivity such as carbonaceous material is added to the cathode catalyst layer. As a result, the electric resistance of the electrode does not increase so that a cathode electrode with high output is provided for a fuel cell. Examples of water repellent materials that can be used as the electrically conductive materials are: (1) graphite intercalate-compounds, (2) activated charcoal, and (3) carbon particles surface-treated with functional groups.

The materials will be explained in detail in the following.

Graphite is a crystal of carbon, and has a lamellar structure with a strong anisotropy. Although it has been known that graphite reacts with various substances to form compounds, the compounds maintain the lamellar structure, which are called graphite intercalation compounds.

The graphite intercalation compounds may be grouped into three categories in accordance with the bonding state of graphite and the reaction substances.

The first one is a covalent bond type, which is a system wherein the reaction substances form a bonds with carbon atoms of graphite. The second one is a system wherein the reaction substances enter the lamellar structure keeping the lateral structure of graphite. The third one is a system wherein the reaction substances bond to sites, which are in a physically specific state, such as lattice defects or crystal grain boundaries.

The third type of graphite intercalation compounds is produced under the particular conditions. The graphite intercalation compounds having water repellency and electric conductivity used in the present invention are preferably the first group (covalent bond type) and the second group (intercalation compounds that keep lamellar structure of graphite after the intercalation).

The covalent bond type graphite intercalation compounds lose flatness of the graphite network thereby to have a waved structure. The physico-chemical properties of the graphite intercalation compounds are quite different from those of graphite. As reactants for forming the covalent bond type graphite intercalation compounds, fluorine (graphite fluoride), oxygen (graphite oxide) are exemplified; from the viewpoint of water-repellency, fluorine (graphite fluoride) is preferable.

Graphite fluoride (CₘFₙ; n, m are natural numbers) have a contact angle of 140° with water, which is much higher than 108° of the contact angle of PTFE with water. Therefore, the water repellency of graphite fluoride is much better than that of PTFE. The water repellency of graphite fluoride can keep the high water repellency even if the ratio of m/n is changed. For example, graphite fluoride of n/m=1 has a contact angle of 140° with water and graphite fluoride of n/m=0.58 has a contact angle of 141°. Thus, the water repellency of graphite fluoride does not greatly depend on the content of fluorine.

On the other hand, electric conductivity of the graphite fluoride greatly depends on n/m. Graphite fluoride of n/m=1 is white and has no electric conductivity. As a content of fluorine decreases, its color changes to white, gray and black to exhibit electric conductivity. Graphite fluoride of n/m=0.58 is black-gray and electrically conductive. In the present invention, graphite fluoride of n/m<1 is preferable material. Graphite fluoride having n/m=1 may be used as a water repellent in place of PTFE. In this case, the graphite having n/m=1 is combined with the graphite fluoride having n/m<1.

In the graphite intercalation compounds, wherein reaction substances enter the lamellar structure, while maintaining a plane structure of graphite, the nature of the graphite layers controls the characteristics of graphite fluoride, and the intercalated substances modify the characteristics.

Graphite, depending on processing methods, has a contact angle of about 90° with water, which is relatively high. Concerning electric conductivity, graphite is classified as a semi-metal because specific resistance in plane σₐ is 2.5×10⁴ S/cm and specific resistance in the C axis σ_{c} is 8.3 S/cm. In the graphite intercalation compounds where the reaction substances enter the plane structure, which is maintained, the relatively high water repellency is kept; the electric conductivity greatly changes depending on kinds of reaction substances.

Depending on the intercalated substances, graphite intercalation compounds become metallic and have electric conductivity larger than graphite by 1 order. The reaction substances or intercalation substances for the graphite keeping the plane structure are alkali metals such as Li, Na, K, etc. alkaline earth metals such as Ca, Sr, Zn, Ba, etc, eare earth metals such as Sm, Eu, Yb, etc, transition metals such as Mn, Ni, Co, Zn, Mo, etc, halogen such as Br₂, ICl, IBr, etc, acids such as HNO₃, H₂SO₄, HF, HFB₄, etc, chlorides such as FeCl₃, FeCl₂, SbCl₅, etc, and fluorides such as SbF₅, AsF₅, etc.

From the viewpoints of stability at electric conductivity and stability at room temperature, graphite intercalation compounds of SbF₅ or AsF₅ is preferable. The graphite intercalation compounds, where SbF₅ or AsF₅ is inserted, electric conductivity in the C-axis greatly increases; in the case of SbF₅, the electric resistance is 1.8×10⁵ S/cm and in the case of AsF₅, the electric resistance is 6.3×10⁵ S/cm. These figures are larger than that of graphite by one order.

As electrically conductive, water-repellent carbonaceous materials, activated charcoal can be used. The activated charcoal is a porous material having fine pores called micropores of 0.002 μm or less in diameter, fine pores called meso pores of 0.002 to 0.05 μm in diameter and fine pores called macro pores of 0.05 μm or more in diameter.

The activated charcoal has a low surface active energy among carbon materials; it shows a strong water repellency. Since the activated charcoal is carbonaceous material, it has good electric conductivity. When the activated charcoal is mixed in the cathode catalyst layer, the electric conductivity can be compatible with the water repellency.

It is possible to use various carbonaceous materials, the surface of which is provided with water-repellent functional groups. Carbonaceous materials such as carbon black, carbon fiber, etc are electrically conductive; when water-repellent functional groups are attached to the surface of them, water-repellency is given. As water-repellent functional groups, there are linear chain hydrocarbons, cyclo-hydrocarbons, aromatic hydrocarbons, etc.

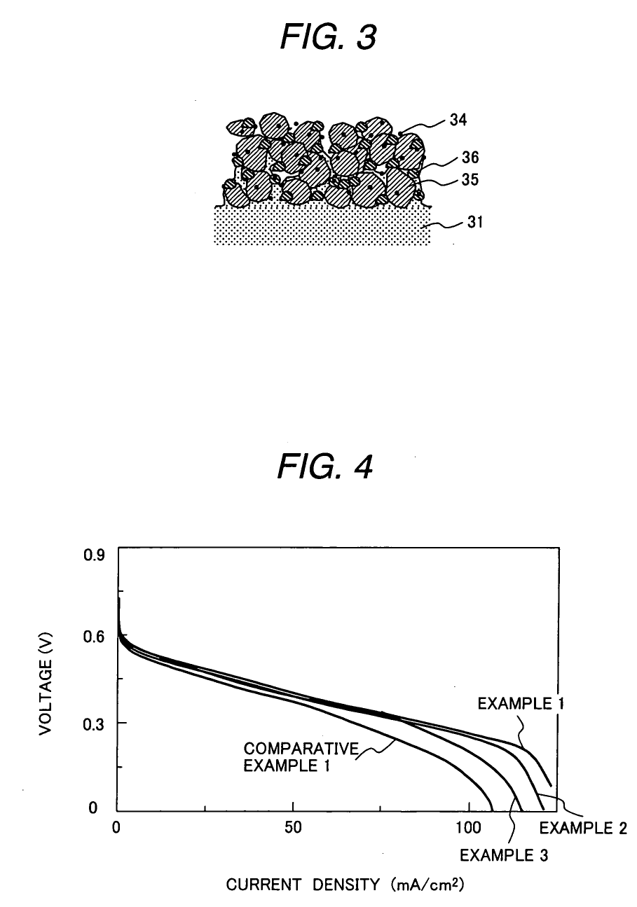

In the following, the MEA of the present invention will be explained by reference to FIGS. 2, 3 in detail. FIG. 2(a) is a plane view of the MEA according to the present invention. FIG. 2(b) is a cross sectional view of the MEA along with the line A-A in FIG. 2(a). FIG. 3 is an enlarged diagrammatic view of a portion circled in FIG. 2(b).

The present invention provides a fuel cell electrode comprising a solid electrolyte and carbon particles, wherein the cathode electrode catalyst layer contains electrically conductive, water-repellent carbonaceous particles. As a result, the cathode catalyst layer keeps electric conductivity and water repellency thereby to reduce an IR drop at a high current density and to increase an output.

In FIG. 3, which is an enlarged diagrammatic view of the circled portion in FIG. 2(b), numeral 31 denotes a solid polymer electrolyte membrane, 32 a cathode catalyst layer, 33 an anode catalyst layer, 34 a catalyst metal, 35 supporting carbon particles, 36 water-repellent, electrically conductive carbon particles.

Since the electrically conductive, water-repellent carbon particles do not hinder the transfer of electrons necessary for electrode reactions, the IR drop at high current density is small and keeps high output. It is possible to obtain high output at high current density by using the MEA containing the above water-repellent carbon particles.

A particle size of the conductive, water-repellent carbon is preferably 0.1 to 10 μm in view of dispersion properties, etc, particularly, 0.1 to 2 μm is more preferable. An amount of the conductive, water-repellent carbons is preferably 5 to 30% by weight based on the total weight of the cathode catalyst layer, more preferably, 5 to 20% by weight. The distribution state of the conductive, water repellent carbon may be homogeneous or in a gradient concentration. The carbon may be present in the catalyst layer as islands.

The solid polymer electrolyte membrane 31 and solid polymer electrolyte contained in the catalyst layer are polymers having proton conductivity. For example, there are sulfonated or alkylene-sulfonated fluoride polymers, polystyrene resins such as perfluorocarbon series sulfonate resins polyperfluorostyrene series sulfonate resins. Further, there are composite solid polymer electrolyte membranes wherein proton conductive inorganic substances such as tungsten oxide hydrate, zirconium oxide hydrate, tin oxide hydrate, silico-tungstate, silico-molybdate, molybdorine acid, etc are micro-dispersed in a heat resistance resin,

On the other hand, as the catalyst metals 34 used in the present invention, at least platinum is used for the cathode and at least platinum or ruthenium is used for the anode. However, the present invention does not limit the kind of catalyst metals. In order to stabilize the electrode catalysts or elongate the life of the electrode catalysts, a third metal such as iron, tin or rare earth metals may be added to the noble metals.

Further, carbon 35 for supporting the catalysts 34 should have a large specific surface area, such as 50 to 1500 m²/g.

Method for preparing the graphite intercalation compounds as the electrically conductive, water-repellent material include (1) “a powder-gas phase/liquid phase reaction method”, wherein graphite and gaseous or liquid intercalate substances are contacted, and (2) “an electrolysis decomposition method” wherein a electrolysis solution containing intercalation substances are decomposed with an electrode. For example, the graphite fluoride CₙFₘ can be prepared by reacting graphite with fluorine gas. It is possible to control the n/m ratio by controlling the reaction time and temperatures. For example, when the temperature is 375° C. and a reaction time is 120 hours, n/m becomes 0.53. If the reaction temperature is 500° C. and the reaction time is 120 hours, n/m becomes 0.75. If the reaction temperature is 600° C. and the reaction time is 120 hours, n/m of the graphite fluoride CₙFₘ became 1.

An example of methods of MEA containing electrically conductive, water-repellent carbon particles is explained in the following. In the example, the ratio of n/m of the graphite is 0.53.

Graphite fluoride, carbon supporting Pt, solid polymer electrolyte and a solvent for dissolving the solid polymer electrolyte are thoroughly mixed to prepare a cathode catalyst paste.

Carbon supporting PtRu alloy, solid polymer electrolyte and a solvent for the solid polymer electrolyte are thoroughly mixed to prepare an anode catalyst paste.

The catalyst pastes are separately sprayed on polytetrafluoroethylene (PTFE) release films and dried at 80° C. to remove the solvent. A cathode catalyst layer and anode catalyst layer are obtained.

The cathode catalyst layer and the anode catalyst layer are bonded to a solid polymer electrolyte membrane by a hot-press method. The release films are removed to obtain an MEA.

In an example of a method of preparing an MEA wherein the graphite intercalation compound is used as the water repellent material, the graphite intercalation compound, carbon supporting Pt, solid polymer electrolyte and a solvent for dissolving the solid polymer electrolyte are thoroughly mixed to prepare a cathode catalyst paste.

Carbon supporting PtRu alloy, solid polymer electrolyte and a solvent for dissolving the solid polymer electrolyte are thoroughly mixed to prepare an anode catalyst paste.

The pastes are sprayed on a solid polymer electrolyte membrane to obtain an MEA.

In place of the graphite fluoride, other graphite intercalation compounds, activated charcoal or carbonaceous materials having water-repellent functional groups on the surface are utilized to prepare an MEA according to the present invention.

In the following, the present invention will be explained by reference to examples in detail. The scope of the present invention will not limited by these examples, however.

### EXAMPLE 1

Graphite fluoride intercalation compound (n/m=0.58) was used as an electrically conductive, water repellent carbon material. The graphite fluoride was synthesized by reacting graphite manufactured by Tokai Carbon Corp. with fluorine gas at 375% for 120 hours.

A cathode electrode containing graphite fluoride was prepared in the following manner.

An electrode catalyst comprising carbon black supporting Pt in an amount of 50% by weight, a Nafion (manufactured by Dupont) solution (5% by weight of Nafion, manufactured by Aldrich Co.) and the graphite fluoride were mixed in a weight ratio (%) of 72:18:10 to prepare a cathode catalyst paste. The ratio of the electrode catalyst to Nafion was 4:1.

On the other hand, an anode catalyst layer was prepared in the following manner.

Electrode catalyst comprising carbon black supporting 50% by weight of PtRu alloy at an atomic ratio of 1:1 and a Nafion solution (5% by weight of Nafion, manufactured by Aldrich Co.) were mixed at a mixing rate of 72.5:27.5 to prepare an anode catalyst paste.

The cathode catalyst paste and the anode catalyst paste were separately coated on PTFE sheet by an applicator method and the pastes were dried to prepare a cathode catalyst layer and an anode catalyst layer. A Pt amount in the cathode catalyst layer was 1.0 mg/cm², and a PtRu amount was 1.0 mg/cm².

The cathode catalyst layer, a Nafion membrane (Nafion 112, 50 μm thick) and the anode catalyst layer were laminated and the catalyst layers were transferred from the PTFE sheet by a hot-press method to manufacture an MEA of the present invention. A hot-press temperature was 160° C. and a hot-press pressure was 80 kg/cm².

A fuel cell shown in FIG. 1 was assembled, using the MEA. Air was supplied to the cathode at a rate of 200 ml/min. An aqueous methanol solution was supplied to the anode at a rate of 10 ml/min. I-V characteristics at 25° C. were measured.

### EXAMPLE 2

As electrically conductive, water-repellent carbon particles, graphite fluoride (CₙFₘ, n/m=0.58) was used. The graphite fluoride was prepared in the same manner as in example 1.

Carbon black supporting 50% by weight of Pt, a Nafion solution (5% by weight of Nafion, manufactured by Aldrich) and graphite fluoride were mixed at a mixing ratio (% by weight) of 64:16:20 to prepare a cathode catalyst paste. A ratio of the electrode catalyst to Nafion is 4:1, which is the same as in example 1. The I-V characteristics were measured under the same conditions as in example 1.

### EXAMPLE 3

As electrically conductive, water-repellent carbon particles, graphite fluoride (CₙFₘ, n/m=0.58) was used. The graphite fluoride was prepared in the same manner as in example 1.

Carbon black supporting 50% by weight of Pt, a Nafion solution (5% by weight of Nafion, manufactured by Aldrich) and graphite fluoride were mixed at a mixing ratio (% by weight) of 76:19:5 to prepare a cathode catalyst paste. A ratio of the electrode catalyst to Nafion is 4:1, which is the same as in example 1. The I-V characteristics were measured under the same conditions as in example 1.

### EXAMPLE 4

As electrically conductive, water repellent carbon particles, activated charcoal having an average particle size of 1 μm and a specific surface area of 1270 m²/g was used. A cathode catalyst layer containing activated charcoal was prepared in the following manner.

Carbon black supporting 50% by weight of Pt, a Nafion solution (5% by weight of Nafion, manufactured by Aldrich) and the activated charcoal were mixed at a mixing ratio (% by weight) of 72:18:10 to prepare a cathode catalyst paste. A ratio of the electrode catalyst to Nafion is 4:1, which is the same as in example 1.

On the other hand, an anode catalyst layer was prepared in the following manner.

Carbon black supporting PtRu alloy of an atomic ratio of 1:1 in a amount of 50% by weight and a Nafion solution (5% by weight, manufactured by Aldrich) were mixed at a mixing ratio % by weight) of 72.5:27.5 to prepare an anode catalyst paste.

The cathode paste and the anode paste were separately coated on a PTFE sheet by an applicator. The coating was dried to prepare a cathode catalyst layer and an anode catalyst layer. An amount of Pt in the cathode catalyst was 1.0 mg/cm² and an amount of PtRu in the anode catalyst layer was 1.0 mg/cm².

The cathode catalyst layer, a Nafion membrane (Nafion 112, 50 μm thick) and the anode catalyst layer were laminated and the catalyst layers were transferred from the PTFE sheet by a hot-press method to manufacture an MEA of the present invention. A hot-press temperature was 160° C. and a hot-press pressure was 80 kg/cm².

I-V characteristics of the MEA were measured under the same conditions as in example 1.

### EXAMPLE 5

As electrically conductive, water repellent carbon particles, carbon black having in its surface aromatic hydrocarbon groups as the surface function groups was used.

A cathode catalyst layer containing the above carbon black having the aromatic function groups was prepared in the following manner.

Carbon black supporting Pt at 50% by weight and a solution containing 5% by weight of Nafion (manufactured by Aldrich) and carbon black having the function groups were mixed at a mixing ratio (% by weight) of 72:18:10 to prepare a cathode catalyst paste. The ratio of the electrode catalyst to Nafion was 4:1.

On the other hand, an anode catalyst layer was prepared in the following manner.

Carbon black supporting PtRu alloy of an atomic ratio of 1:1 in a amount of 50% by weight and a Nafion solution (5% by weight, manufactured by Aldrich) were mixed at a mixing ratio % by weight) of 72.5:27.5 to prepare an anode catalyst paste.

The cathode paste and the anode paste were separately coated on a PTFE sheet by an applicator. The coating was dried to prepare a cathode catalyst layer and an anode catalyst layer. An amount of Pt in the cathode catalyst was 1.0 mg/cm² and an amount of PtRu in the anode catalyst layer was 1.0 mg/cm².

The cathode catalyst layer, a Nafion membrane (Nafion 112, 50 μm thick) and the anode catalyst layer were laminated and the catalyst layers were transferred from the PTFE sheet by a hot-press method to manufacture an MEA of the present invention. A hot-press temperature was 160° C. and a hot-press pressure was 80 kg/cm².

I-V characteristics of the MEA were measured under the same conditions as in example 1.

### EXAMPLE 6

Although in examples 1 to 5, air was supplied to the cathode at a flow rate of 200 ml/min. In example 6, air was not supplied forcibly, but air was supplied by natural breathing (air is not supplied forcibly, but supplied by natural diffusion). A test cell shown in FIG. 1 was used.

Air was supplied by natural convection. This type of fuel cells has smaller outputs than the forcible air supply system.

An aqueous methanol solution was supplied to an anode at a rate of 10 ml/min. I-V characteristics were measured at 25° C., using the test cell. Table 2 shows generation voltages when 100 mA/cm² was supplied to the MEAs. The voltages are results of evaluation of the MEAs of examples 1, 4 and 5 and of comparative example under natural breathing. As shown in Table 2, the outputs were increased in any of graphite fluoride, activated charcoal and carbon black having water-repellent function groups, compared with the electrode using PTFE.

In the case of natural air circulation, an increase of generation voltage is larger than that of the air forcible supply type. The effect of the water-repellency becomes more remarkable than air forcible supply system.

### COMPARATIVE EXAMPLE 1

As a water-repellent material, PTFE was used. A cathode catalyst layer was prepared in the following method.

PTFE dispersion (manufactured by Daikin Industries), carbon black supporting PtRu alloy of an atomic ratio of 1:1 in a amount of 50% by weight and a Nafion solution (5% by weight, manufactured by Aldrich) were mixed at a mixing ratio (% by weight) of 72:18:10 to prepare a cathode catalyst paste. A mixing ratio of the electrode catalyst to Nafion is 4:1, as same as in Example 1. Other preparation conditions were the same as in example 1.

FIG. 4 shows I-V characteristics of test cells of examples 1, 2, 3 and test cells of comparative example 1. In the case of examples 1, 2 and 3, wherein graphite fluoride (n/m=0.58) was used as a water repellent material, generation voltages at high current density are higher than those of comparative example, wherein PTFE was used as a water-repellent material. In the examples of the present invention, the resistance of the electrode was lowered, compared with the comparative example, an IR drop became smaller and output at high current density was increased.

The output voltage of the test cell of example 1 wherein an amount of graphite fluoride was 10% by weight was the highest among the test cells. The output voltage of the example 1 test cell was the highest, the output voltage of example 2 wherein 20% by weight of graphite fluoride was next, and the output voltage of example 3 was the third.

Since the amount of catalyst in examples 1, 2 and 3 was constant, thickness of the catalyst layers of the examples are different in accordance with additive amounts of graphite fluoride. The catalyst layer of example 2 wherein 20% by weight of graphite fluoride was added has a thickness larger than that of example 1. Since air did not enter into reaction sites of the interior of the catalyst layer of example 2, the output voltage was low. Although a thickness of the catalyst layer containing 5% by weight of graphite fluoride of example 3, water-repellency was insufficient so that the output voltage was low. The results shown in Table 1 suggest that there may be an optimum range of the additive amount of the water-repellent material.

Table 1 shows generation voltages under a current density of 100 mA/cm². The graphite fluoride, activated charcoal and carbon black having water-repellent function groups are better water-repellent material than PTFE.

When carbon black having the water-repellent function groups is used, a generation voltage is rather lower than the case where graphite fluoride and activated charcoal are used. This was caused by lowering of electric conductivity of the carbon black due to introduction of the water-repellent function groups on the surface.

It is possible to improve electric conductivity by selection of proper function groups and an amount of proper introduction, etc.

TABLE 1

| Water-repellent | Generation Voltage (V) |
|---|---|
| Comparative example 1 (PTFE) | 0.14 |
| Example 1 (Graphite fluoride) | 0.28 |
| Example 4 (Activated charcoal) | 0.26 |
| Example 5 (Carbon black having | 0.20 |
| function groups) | |

1. A fuel cell comprising an anode for oxidizing fuel, a cathode for reducing oxygen and a solid polymer electrolyte membrane sandwiched between the anode and the cathode, wherein the cathode comprises a catalyst supporter having a catalyst metal and a material having a polymer proton conductivity and a material having water-repellency, the water-repellent material being electrically conductive.

2. The fuel cell according to claim 1, wherein the water-repellent material is a water-repellent carbonaceous material.

3. The fuel cell according to claim 2, wherein the water-repellent carbonaceous material is graphite intercalation compound.

4. The fuel cell according to claim 3, wherein the graphite intercalation compound is graphite fluoride represented by CₙFₘ, where n and m are natural numbers.

5. The fuel cell according to claim 4, wherein relation between n and m in the graphite fluoride represented by CₙFₘ is expressed as n/m<1.

6. The fuel cell according to claim 2, wherein the water-repellent carbonaceous material is activated charcoal.

7. The fuel cell according to claim 2, wherein the water-repellent carbonaceous material has water-repellent function groups.

8. The fuel cell according to claim 1, wherein the fuel contains methanol.

9. A membrane electrode assembly comprising an anode catalyst layer, a proton conductive polymer electrolyte membrane and a cathode catalyst layer, the anode catalyst layer, the membrane and the cathode catalyst layer being laminated and united, wherein the catalyst layers contain carbon supporting metal catalyst and a water-repellent material, the water-repellent material being electrically conductive.

10. The membrane electrode assembly according to claim 9, wherein the water-repellent material is graphite fluoride.
